(19) United States
(12) Patent Application Publication
(10) Pub. No.: US 2010/0326174 A1
(43) Pub. Date: Dec. 30, 2010

(54) EXTERNAL HYDROSTATIC TESTER

(76) Inventor: Leon MYRICK, Killam (CA)

Correspondence Address: DAVIS & BUJOLD, P.L.L.C., 112 PLEASANT STREET, CONCORD, NH, 03301, US

(21) Appl. No.: 12/491,569

(22) Filed: Jun. 25, 2009

(51) Int. Cl. G01M 3/28

(52) U.S. Cl. 73/49.8

(57) ABSTRACT

An external hydrostatic tester for testing welds on a pipe includes a tester body having a first portion and a second portion, each of the first and second portions having a first side, a second side, and an inner surface. The first and second portions are movable between a released position and a connected position. A testing cavity on the inner surface of first portion and second portion has a port for supplying pressurized fluid and is connected to a pressure sensor. Seals positioned on the inner surface of the tester body seal against a pipe and an adjustable compression member compresses the seals against the pipe at selected locations.

### FIELD

External hydrostatic testers

### BACKGROUND

Once two parts of a pipeline have been welded together, it is necessary to test the weld, which is generally done using a hydrostatic test. This may be done by using, for example, the isolation tools or weld test tools by Car-ber Testing Services of Point Edward, Ontario, Canada. The weld test tool is also described in U.S. Pat. No. 5,844,127 (Berube et al.), entitled “Apparatus for isolating or testing a pipe segment”.

### SUMMARY

There is provided an external hydrostatic tester for testing welds on a pipe copmrising a tester body having a first portion and a second portion each having a first side, a second side, and an inner surface. First and second portions are movable between a released position and a connected position and movable from each other in the released position. Seals are positioned on the inner surface of the first portion and the second portion toward each of the first side and the second side. A test cavity positioned on the inner surface of the first portion and the second portion between the seals is supplied with pressurized fluid from a port. A pressure sensor senses the pressure of the fluid in the testing cavity. An adjustable compression member compresses seals against the pipe at selected locations.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view of an external hydrostatic tester.

FIG. 2 is a side elevation view of the external hydrostatic tester.

FIG. 3 is a side elevation view of a variation of the external hydrostatic tester.

FIG. 4 is a side view in section of the external hydrostatic tester placed on a welded section of pipe.

FIG. 5 is a side view in section of a variation of the external hydrostatic tester shown in FIG. 2 placed adjacent to a flange.

FIG. 6 is a front elevation view of the external hydrostatic tester in the release position.

### DETAILED DESCRIPTION

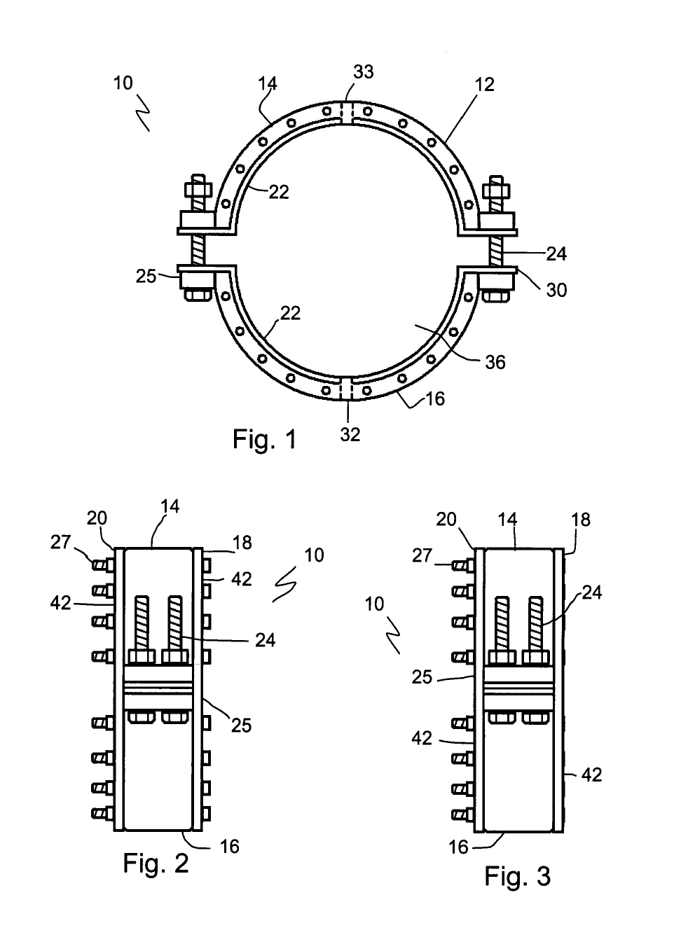

An external hydrostatic tester generally identified by reference numeral 10, will now be described with reference to FIG. 1 through FIG. 6.

### Structure and Relationship of Parts:

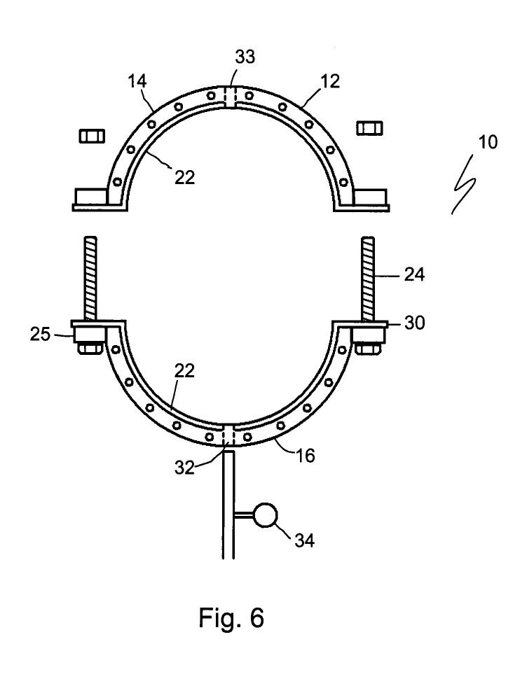

Referring to FIG. 1, external hydrostatic tester 10 includes a tester body 12 having a first portion 14 and a second portion 16. As shown, first portion 14 and second portion 16 are two halves of a circle. Referring to FIG. 2, each of first and second portions 14 and 16 have a first side 18, a second side 20, and an inner surface 22, referring to FIG. 1. Referring to FIG. 1 and FIG. 6, first and second portions 14 and 16 are movable between a released position and a connected position. Referring to FIG. 2, as shown, first and second portions 14 and 16 are connected by bolts 24, which may also be studs, through flanges 25. Other options are available, for example, first and second portions 14 and 16 may be hinged on one side, and connected by bolts or latches on the other. Bolts 24 (or studs) are preferred, as it allows portions 14 and 16 to be tightened together if necessary.

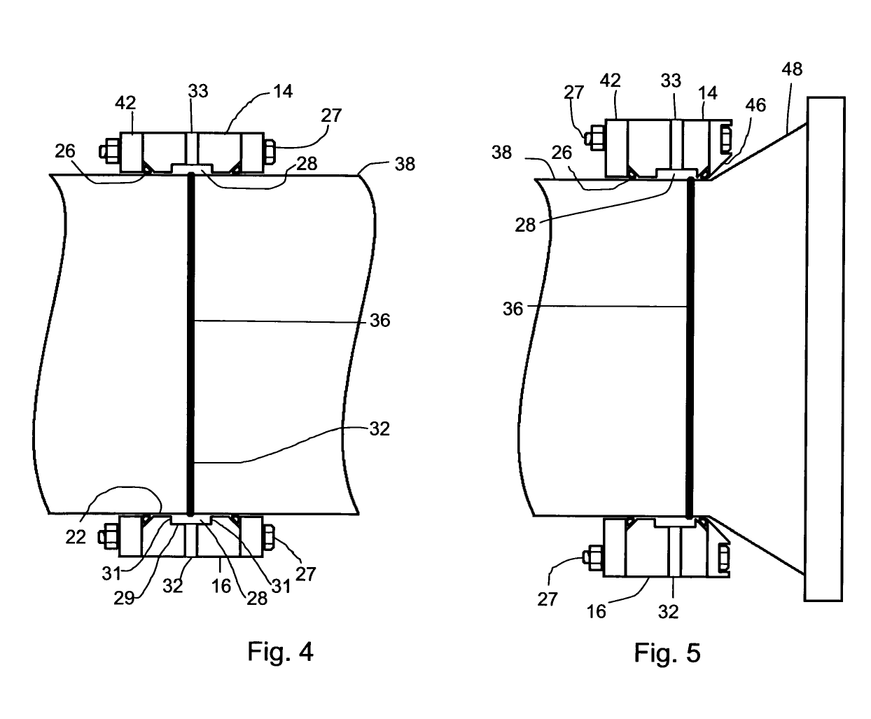

Referring to FIG. 4, there are seals 26 positioned on inner surface 22 of first portion 14 and second portion 16 toward each of first side 18 and second side 20. There is a testing cavity 28 on inner surface 22 of first portion 14 and second portion 16 positioned between seals 26. Testing cavity 28 is formed from a recessed face 29 and two sides 31 that extend toward the center of tester 10. Seals 26 are used to prevent fluid from escaping pas the point at which sides 31 meet pipe 38. Bolts 24 (or studs) around the outside allow a user to selectively increase the sealing pressure from seals 26 against a pipe 38 to prevent leaks due to imperfections in pipe 38. Referring to FIG. 1, there are also seals 30 between flanges 25 to prevent leakage where they connect.

Referring to FIG. 6, a port 32 for supplying pressurized fluid to the testing cavity 28 is connected to a pressure sensor 34 for sensing the pressure of the fluid in the testing cavity 28. A vent hole 33 is positioned above port 32, which is capped with a pressure sensor 34 (shown in FIG. 6) when testing cavity 28 is full. Referring to FIG. 6, in the released position, the first portion 14 and the second portion 16 are movable relative to each other. Referring to FIG. 4, in the connected position, the inner surface 22 contacts a pipe receiving opening 36 and the seals 26 seal against a pipe 38 positioned in the pipe receiving opening 36. An adjustable compression member 40 compresses the seals 26 against the pipe 38 at selected locations.

Referring to FIG. 4 and FIG. 5, the external hydrostatic tester 10 has an adjustable compression member 40 comprising a compression plate 42 on a first side 18 and on a second side 20 of each of the first portion 14 and the second portion 16 of the external hydrostatic tester 10. The plate 42 connects to the tester body 12 by a series of adjustable clamping members, such as bolts 24 that extend through plates 42 and first or second portion 14 or 16, referring to FIG. 2. The seals 26 are positioned on an angled face on the inner surface 22 such that the seals 26 are compressed at selected locations by adjusting the clamping pressure to increase the sealing pressure of the seals 26, referring to FIG. 4 and FIG. 5.

### Operation:

Referring to FIG. 6, the external hydrostatic tester 10 in the released position is positioned on a pipe 38 such that first portion 14 and second portion 16 of the tester body 12 are on opposite sides of the pipe 38 and inner surface 22 is adjacent the pipe 38, as shown in FIG. 4. Bolts 24 located on the flanges 25 of the tester body 12 are tightened such that first portion 14 and second portion 16 are placed in the connected position around a pipe receiving opening 36, referring to FIG. 1.

Referring to FIG. 4 and FIG. 5, in the connected position inner surface 22 is in contact with pipe 38. Seals 26 are positioned against pipe 38 and on an angled face of the inner surface 22 such that the seals 26 are compressed at selected locations by adjusting the clamping pressure of the compression plate 42 to increase the sealing pressure of the seals 26. This is necessary, for example, if pipe 38 is not a perfect circle, or if pipe 38 has other imperfections. Seals 30 in the flanges 25 prevent leakage where the flanges 25 meet. Pressurized fluid is then supplied to the test cavity 28 via a port 32 (shown in FIG. 6). Referring to FIG. 4, as the fluid enters cavity 28, the air is permitted to escape through vent 33. Once filled, referring to FIG. 6, vent 33 is plugged to seal cavity 28 with a pressure sensor 34. Alternatively, pressure sensor 34 could be positioned at any other convenient location in contact with cavity 28. Pressure sensor 34 senses the pressure of the fluid in the testing cavity 28 with a change in pressure indicating a leak. Once the desired pressure is reached, the pressure sensor 34 is monitored to see whether there is a drop in pressure, indicating a leak. If there is a drop in pressure, tester 10 is also checked to see whether there is a leak through seals 30 or 26, in which case the respective bolts 24 or 27 are tightened.

If it is determined that there is a leak, the leak may be localized by applying a dye to the weld, such as ARDROX™ produced by Chemetall PLC, and therefore which portion of the weld must be redone. Alternatively, this product could also be used as the testing medium, such that it would already be applied if it was necessary to localize the leak.

### Advantages:

By using an external tester, it becomes immediately apparent whether any loss of pressure is due to the seals, and which portion of the seals must be tightened to correct the leak. In addition, it may be installed in various locations that may be otherwise difficult to reach for an internal tester, such as bends in the pipeline.

### Variations:

FIGS. 3 and 5 show a variation that allows hydrostatic tester 10 to be more easily positioned on a pipe that is welded to a fitting such as a flange or reducer, or to a bend. As can be seen, plate 42 has a tapered inner surface 46 that allows it to be positioned against a fitting 48. In addition, the heads of bolts 24 are recessed into plate 42.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An external hydrostatic tester for testing welds on a pipe, comprising:
a tester body having a first portion and a second portion, each of the first and second portions having a first side, a second side, and an inner surface, the first and second portion being movable between a released position and a connected position;
seals positioned on the inner surface of the first portion and the second portion toward each of the first side and the second side;
a testing cavity on the inner surface of the first portion and the second portion positioned between the seals;
a port for supplying pressurized fluid to the testing cavity;
a pressure sensor for sensing the pressure of the fluid in the testing cavity;
in the released position, the first portion and the second portion being movable relative to each other;
in the connected position, the inner surface defining a pipe receiving opening and the seals sealing against a pipe positioned in the pipe receiving opening; and
an adjustable compression member for compressing the seals against the pipe at selected locations.

2. The external hydrostatic tester of claim 1, wherein the adjustable compression member comprises a compression plate on a first side and on a second side of each of the first portion and the second portion, the plate connected being to the tester body by a series of adjustable clamping members, the seals being positioned on an angled face on the inner surface such that the seals are compressed at selected locations by adjusting the clamping pressure to increase the sealing pressure of the seals.

3. The external hydrostatic tester of claim 1, wherein the first side of each of the first and second portions comprises an angled inner edge.
